(19) United States
(12) Patent Application Publication
(10) Pub. No.: US 2015/0220885 A1
(43) Pub. Date: Aug. 6, 2015

(54) SYSTEM AND METHOD FOR REVIEWING JOB APPLICANTS

(71) Applicant: Linkedln Corporation, Mountain View, CA (US)

(72) Inventor: Tomer Cohen, Mountain View, CA (US)

(73) Assignee: Linkedln Corporation, Mountain View, CA (US)

(21) Appl. No.: 14/173,637

(22) Filed: Feb. 5, 2014

(51) Int. Cl. G06Q 10/10; G06F 3/0488; G06F 17/30; H04L 29/08

(52) U.S. Cl. CPC G06Q 10/1053; H04L 67/02; H04L 67/30; G06F 3/0488; G06F 17/3053

(57) ABSTRACT

A tool for assisting a job recruiter or other person in reviewing candidates for a job position receives data relating to a job candidate. The data relating to the job candidate is displayed on a computer display device having a touch sensitive screen. Input is received from the job recruiter via the touch sensitive screen. The input relates to a decision on the job candidate for the employment position. The decision and data relating to the job candidate are stored, discarded, or forwarded to another memory device based on the input from the user.

### TECHNICAL FIELD

The subject matter disclosed herein generally relates to a system and method for reviewing job applicants.

### BACKGROUND

Job postings to advertise an available job and solicit applications for the job are well known. Job postings have been incorporated into newspapers, periodicals, and the like for centuries. More recently, search engines and websites related to facilitating job searching have presented such available jobs electronically. In such circumstances, entities advertising jobs conventionally pay a fee to the owner of the platform on which the advertisement is to be displayed. As a result, advertisements may conventionally be displayed generally to most if not all of the users who access the platform.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server.

FIG. 3 is a block diagram showing some of the functional components or modules that comprise a recommendation engine.

FIG. 4 is a detailed example of the social network server.

FIG. 5 is a depiction of an example user interface screen that can be displayed by the social network on the user device.

FIG. 6 is a flow diagram illustrating an example of the method operations involved in a method of pre-processing user profiles with a characteristic extraction engine.

FIG. 7 is a flow diagram illustrating an example of the method operations involved in a method of generating a relevance between a user profile and a job profile.

FIG. 8 is a flow diagram illustrating an example of presenting a message relating to a job to a user based on an aggregate job score.

FIG. 9 is a flow diagram illustrating an example of an embodiment that permits a user or member of an online social networking service to create a modified profile for use in connection with a job posting service.

FIG. 10 is a flow diagram illustrating an example of an embodiment that automatically recommends employment positions to a user or member of an online social network service.

FIG. 11 is a flow diagram illustrating an example of an embodiment that ranks a member of an online social network against others in connection with a current job posting.

FIG. 12A is a depiction of an example user interface screen that can be displayed by a user characteristics-based job posting service.

FIG. 12B is a depiction of an example user interface screen that can be displayed by a user characteristics-based job posting service.

FIG. 12C is a depiction of an example user interface screen that can be displayed by a user characteristics-based job posting service.

FIG. 13 is a depiction of an example user interface screen that can be displayed by a user characteristics-based job posting service.

FIG. 14 is a depiction of an example user interface screen that can be displayed by a user characteristics-based job posting service.

FIG. 15 is a depiction of an example user interface screen that can be displayed by a user characteristics-based job posting service.

FIG. 16 is a depiction of an example user interface screen that can be displayed by a user characteristics-based job posting service.

FIG. 17 is a flow diagram illustrating an example of an embodiment that permits a job recruiter or other individual to electronically peruse through job applicants and to take an initial action regarding those job applicants.

FIG. 18 is a depiction of an example user interface screen that can be displayed on a mobile device by a user characteristics-based job posting service.

FIG. 19 is a block diagram illustrating components of a machine able to read instructions from a machine-readable medium.

### DETAILED DESCRIPTION

Example methods and systems are directed to the generation of user profile-based or member-based job postings. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

While broad dissemination of a job posting may be desirable in certain circumstances, it may be inefficient for a job-posting entity to display jobs to users or members who are unqualified for the related job or otherwise not desirable to the hiring entity. Similarly, it may be inefficient or undesirable for a user or member to receive job postings that are unrelated to their field of expertise or interests. Consequently, a system has been developed that displays job postings to users and/or members of a social network based on characteristics, such as the user's social network profile, a modified user's social network profile (resulting in a user preference), the user's behavior or activities, and the user's social graph, such as people, companies, and groups that the user or member has connected with, follows, or joins within the social network. In this way, a user or member may seamlessly receive pertinent job postings based on their prior social network activity. Relatedly, job posting entities may sponsor job postings on the social network or on a platform with access to the user's social network characteristics with the increased expectation that the expense of sponsoring a job posting may be relatively more likely to result in the job posting being presented to a user with suitable characteristics.

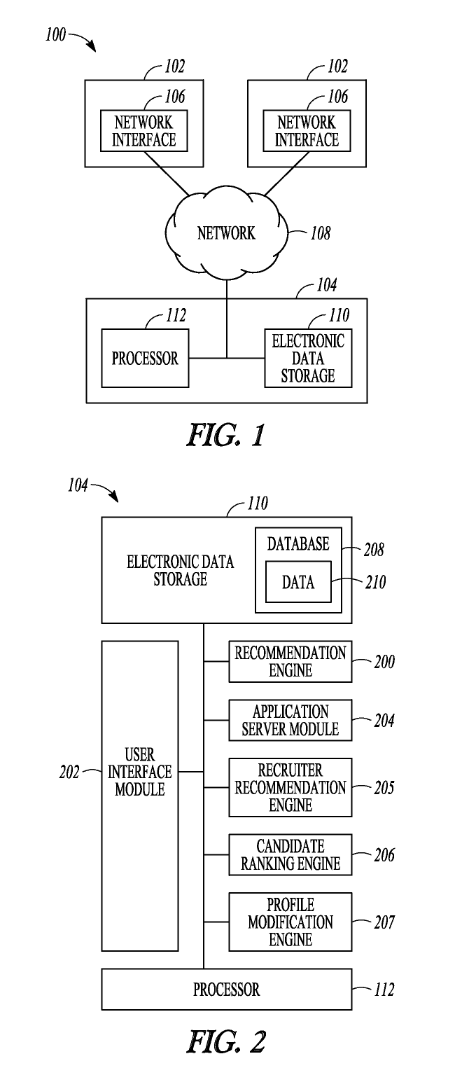

FIG. 1 is a block diagram of a system 100 including user devices 102 and a social network server 104. User devices 102 can be a personal computer, netbook, electronic notebook, smartphone, or any electronic device known in the art that is configured to display web pages. The user devices 102 can include a network interface 106 that is communicatively coupled to a network 108, such as the Internet.

The social network server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The social network server 104 can store information in the electronic data storage device 110 related to users and/or members of the social network, such as in the form of user characteristics corresponding to individual users of the social network. For instance, for an individual user, the user's characteristics can include one or more profile data points, including, for instance, name, age, gender, profession, prior work history or experience, educational achievement, location, citizenship status, leisure activities, likes and dislikes, and so forth. The user's characteristics can further include behavior or activities within and without the social network, as well as the user's social graph. For an organization, such as a company, the information can include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

User characteristics described above can generally include user profile characteristics, in that they are typically defined by a single discrete label, such as a number, a place, or a binary status. Characteristics are included in user behavior, such as can be identified based on user activity within the social network generally. For instance, a user who engages in job searches, such as by entering job keywords into a search engine either of the social network or independent of the social network, can be deemed to have characteristics such as currently seeking a job, and job characteristics that the user is seeking, such as job field, pay grade, location, and the like. Additional user behavior or activities, such as messages to job recruiters, job applications filled out or submitted, and messages to particular companies can also be incorporated. As such, user actions both within and without the social network can be utilized to determine user characteristics such as user behavior.

Activity and behavioral data can be obtained by monitoring and tracking the interactions that a user has with various applications, services and/or content that are provided by, or, integrated or otherwise associated with, the social network service. For example, a social network service may provide any number and variety of applications and/or services with which a member interacts. Similarly, a variety of third-party applications and services may leverage various aspects of the social network service, for example, via one or more application programming interfaces (APIs). A few examples of such applications or services include: search engine applications and services, content sharing and recommendation applications (e.g., photos, videos, music, hyperlinks, slideshow presentations, articles, etc.), job posting and job recommendation applications and services, calendar management applications and services, contact management and address book applications and services, candidate recruiting applications and services, travel and itinerary planning applications and services, and many more.

Analysis of social graph data may signal a member's interest in various job profiles. For instance, in some examples, by analyzing certain social graph data, characteristics can be identified that are suggestive of active job-seeking activity. For example, members who are actively seeking particular jobs may be more likely to follow other members of the social network service, or establish new connections with other members in a very concentrated or shortened time span—particularly other members who are job recruiters for particular job types, or who are associated with a job recruiting function. Similarly, members who are actively seeking jobs of a particular type may be more likely to follow certain companies at which there are open job positions matching the member's skills, or having the same job title as may be desired by the member. Members who are actively seeking particular job types may be more likely to join certain online groups—particularly those groups that exist primarily to aid job seekers. Accordingly, by analyzing social graph data to identify the entities with which a member is establishing associations or connections, and the timing and frequency of the activity, the job-seeking intentions of a member may be inferred, and used in the derivation of a metric representing the member's job-seeking propensity.

In various embodiments, the system 100 includes logic that can identify user profiles (and/or user preferences) that conform to a given job profile. In general, a user profile includes information about the user that is extracted from data in the system about the user or actions of the user on the system (e.g., as noted above, a user may be identified as an active job seeker if the user is visiting job search sites). In general, a user preference includes information that is directly entered into a system by a user, such as a user indicating that he or she is looking for a job with a minimum salary. In various examples, upon receiving a request to identify user profiles (and/or user preferences) similar to a particular job profile, the system may analyze a variety of user profiles (and/or user preferences) to select one or more user profiles (and/or user preferences) that have the highest aggregate job scores with respect to the job profile. The identification can be in real-time, understood to be an analysis that is conducted essentially immediately upon receiving the job profile. After identifying the most similar user profiles (and/or user preferences) (e.g., those with the highest aggregate job scores), the system 100 may transmit information related to the job to the selected users.

In various examples, the system 100 can generate a list of user characteristics with the highest aggregate job scores. The list can be presented to the entity posting the job offer, such as a job recruiter. The job recruiter can identify users who have user characteristics that are desirable for recruiting and manually select users of the social network to whom a message relating to the job can or should be presented.

In various examples, a recommendation service or feature may generate an average user characteristic based on the aggregate user characteristic information of all or some selected users for a particular job. For instance, the recommendation service may select the average user characteristic as an input to the user characteristic matching algorithm, and identify user characteristics that are similar to the model job profile for the job profile. For each user characteristic that is determined to be similar to the average user characteristic for a particular job profile, the recommendation service may recommend to a user having a user characteristic similar to the job profile for the instant job, that the user be presented with the job if the user has not already been so presented.

The ability to accurately identify in real-time or essentially real-time a set of user characteristics (and/or user preferences) most similar to a job profile (or, in various examples, a set of company profiles most similar to user characteristics) can be achieved with a general recommendation engine. Accordingly, at least in some examples, the recommendation engine provides a recommendation service that can be customized for use with multiple applications or services. A recommendation entity can be a collection of information organized around a particular concept that is supported by the system 100 in general, and the recommendation engine in particular. For instance, some examples of recommendation entities are: user characteristics, interest groups, companies, advertisements, events, news, discussions, tweets, questions and answers, and so forth. Accordingly, in some examples, by specifying the particular characteristics of two recommendation entities to be compared, and by specifying a particular algorithm for use in generating an aggregate score, such as in the instant example an aggregate company score, for the two recommendation entities, the recommendation engine can be configured and customized to perform such tasks as: generate aggregate job scores for use in recommending job listings to a user; generate aggregate job scores for use in recommending particular interest groups that a user might be interested in joining; generate aggregate job scores for use in displaying an appropriate or relevant advertisement to a particular user, and many others.

In an example, the recommendation engine operates in two phases. In the first phase, the data representing each individual instance of a particular recommendation entity, such as the user characteristic (and/or the user preference) and the job profile, is processed by a characteristic extraction engine to extract the relevant characteristics on which matching analysis is to be performed. In various examples, in the case of a user profile, only certain characteristics or portions of a user's profile may be selected for use in determining the similarity of any two profiles, such as the user profile and a job profile. As such, during the first phase, a characteristic extraction engine processes each user profile to extract the relevant profile characteristics from each user profile, along with behavior characteristics and social graph characteristics. In addition to simply extracting certain characteristics from relevant recommendation entities, the characteristic extraction engine may derive certain characteristics based on other information included in the recommendation entity, such as from the user profile (or user preference).

In an example, one characteristic that may be used to identify similarities between user profiles (or user preferences) and a job profile is work experience. Work experience may be included as a characteristic in a user profile directly or may be arrived at indirectly, such as by being measured in the number of years since a user graduated from a selected educational institution or achieved a particular educational level. While work experience, in an example, may not be included as raw data in a user's profile, it may be derived with a calculation if the user's graduation date is specified in the user's profile. In addition, in some examples, the characteristic extraction engine may standardize and/or normalize various characteristics, such as a user's job or position title, or the name of a company at which a user has indicated being employed. In some examples, certain profile characteristics may be retrieved from external data sources, using other information included in the recommendation entity as part of a query to the external data source.

The first phase may occur in real-time or as a background operation, such as offline or as part of a batch process. In some examples that incorporate relatively large amounts of data to be processed, the first phase may be achieved via a parallel or distributed computing platform. Once the relevant characteristics have been extracted, computed, derived, or retrieved, relevant characteristics of the one or more selected users or jobs can be stored as a pre-processed recommendation entity. For instance, in the case of user characteristics, the characteristic extraction process can result in enhanced user characteristics that include only the relevant characteristics extracted from a user's characteristics as well as any derived or retrieved characteristics, such as profile characteristics. The enhanced characteristics can be used during the recommendation engine's second phase, when the matching engine compares the relevant characteristics from the job profile against each user characteristics set until those user characteristics with the highest aggregate job scores are identified.

In an example, during the second phase, the matching engine of the recommendation engine uses a configuration file that is customized for the particular analysis being performed. For example, a first configuration file (referred to herein as a profile matching configuration file) may exist for use in identifying user profiles similar to a job profile, whereas a second configuration file—specifying different characteristics from different recommendation entities to be compared, and a different algorithm for computing the matching scores—may be specified for determining the job listings that are most likely to be of interest to a particular user. As such, by configuring the characteristic extraction engine to extract relevant data from certain recommendation entities, and customizing the analysis performed by the matching engine with an appropriate configuration file, a wide variety of recommendation operations can be achieved with the general recommendation engine.

FIG. 2 is a block diagram illustrating various components of a social networking server 104 with a recommendation engine 200 for identifying similarities between different recommendation entity types, such as user characteristics (and/or user preferences) and job profiles. In an example, the social networking server 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 200, generates various user interfaces (e.g., web pages) with data retrieved from various data sources in the data layer. With some embodiments, individual application server modules 204 are used to implement the functionality associated with various services and features of the system 100. For instance, the ability to identify user characteristics (and/or user preferences) similar to a job may be a service implemented in an independent application server module 204. Similarly, other applications or services that utilize the recommendation engine 200 may be embodied in their own application server modules 204. Even more specifically, in other embodiments, a recruiter recommendation engine 205 generates a recommendation for a job candidate based on input of a recruiter, a candidate ranking engine 206 generates a ranking of a job candidate compared to other employees and other job candidates, and profile modification engine 207 permits a user or member of an online social networking service to modify his or her profile in the online social networking service.

The data layer can include several databases, such as a database 208 for storing recommendation data, such as user characteristics (and/or user preferences) and job profiles, and can further include additional social network information, such as interest groups, companies, advertisements, events, news, discussions, tweets, questions and answers, and so forth. In some examples, the recommendation entity data is processed in the background (e.g., offline) to generate pre-processed entity data that can be used by the recommendation engine, in real-time, to make recommendations generally, and to identify user profiles similar to a job profile. In an example, the recommendation engine 200 may retrieve and process user characteristic data 210, including a user profile, user behavior, and a user social graph, in the database 208 to identify user characteristics similar to a job profile. The database 208 can store application configuration data, including one or more configuration files for use with the recommendation engine 200.

In various examples, when a person initially registers to become a user (and/or member) of the system 100, the person can be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information can be stored, for example, in the database 208.

Once registered, a user may invite other users, or be invited by other users, to connect via the system 100. A “connection” may involve a bi-lateral agreement by the users, such that both users acknowledge the establishment of the connection. Similarly, with some embodiments, a user may elect to “follow” another user. In contrast to establishing a “connection”, the concept of “following” another user typically is a unilateral operation, and in some examples, does not require acknowledgement or approval by the user that is being followed. When one user follows another, the user who is following may receive automatic notifications about various activities undertaken by the user being followed.

The system 100 may provide a broad range of other applications and services that allow a user the opportunity to share and receive information, often customized to the interests of the user. In some examples, the system 100 may include a photo sharing application that allows users to upload and share photos with other users. In some examples, users may be able to self-organize into groups, or interest groups, organized around a subject matter or topic of interest. With some embodiments, users may subscribe to or join groups affiliated with one or more companies. For instance, with some embodiments, users of the system 100 may indicate an affiliation with a company at which they are employed, such that news and events pertaining to the company are automatically communicated to the users. In some examples, users may be allowed to subscribe to receive information concerning companies other than the company with which they are employed. With many of these applications and services, one or more recommendation entities may be involved. For instance, in addition to identifying user characteristics that are similar to a job profile, the recommendation engine 200 may be configured and customized to identify groups, companies or photos that are likely to be of interest to a particular user.

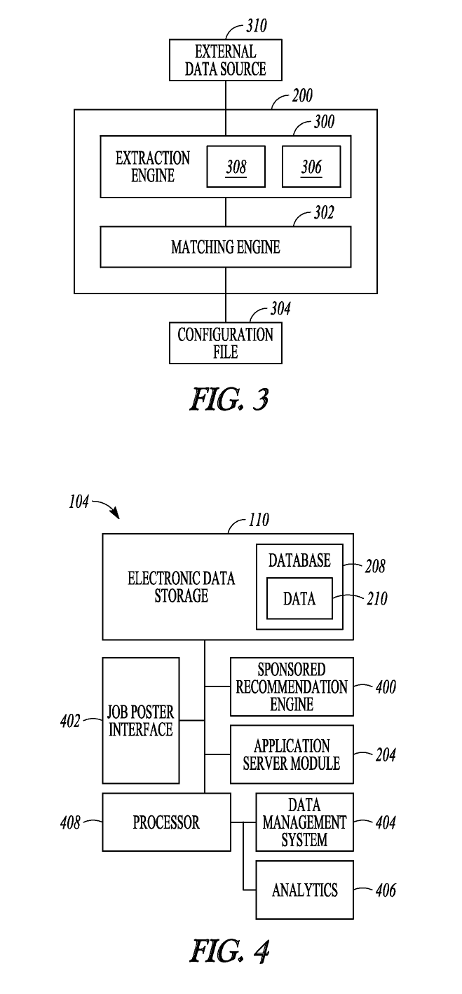

FIG. 3 is a block diagram showing some of the functional components or modules that comprise a recommendation engine 200, in some examples, and illustrates the flow of data that occurs when performing various operations of a method for identifying and presenting user profiles (and/or user preferences) that are similar to a job profile. As illustrated, the recommendation engine 200 consists of two primary functional modules—a characteristic extraction engine 300 and a matching engine 302. The characteristic extraction engine 300 can be customized to extract various characteristics from various recommendation entities, and then operating the matching engine 302 under the direction of a particular configuration file 304 to perform a particular type of matching operation that is specific to the requesting application. Accordingly, depending upon the particular inputs to the recommendation engine 200 and the desired outputs, different configuration files 304 may be used to compare different characteristics of different recommendation entities. For instance, to identify user characteristics that are similar to a job profile, a particular configuration file 304 (referred to herein as a profile matching configuration file) may be used, while different configuration files 304 may be used to perform other tasks, such as identify jobs that a user may be interested in (based on, for example, user preferences).

In the case of identifying user characteristics (and/or preferences) similar to a job profile, the profile matching configuration file 304 is used as an input to the matching engine 302 to specify the various user characteristics that the matching engine is to extract from the pre-processed user profile data 210 and to compare. In addition, the profile matching configuration file 304 can specify an algorithm for comparing characteristics and generating an overall matching score.

In various examples, each user's and job's data 210 is provided as input to the characteristic extraction engine 300, processed by the characteristic extraction engine 300, and then output and stored as pre-processed user characteristic data 210. In some examples, the characteristic extraction engine 300 may extract only relevant characteristics from whatever recommendation entity is being processed by the characteristic extraction engine. So, for example, in the case of a user profile, the characteristic extraction engine 300 may extract only the profile characteristics that are necessary for making the determination of whether a user profile (and/or user preference) is similar to a job profile. However, in some examples, all characteristics are extracted, while only certain characteristics are further processed or refined.

As illustrated, the characteristic extraction engine 300 includes a characteristic derivation module 306 and a data retrieval module 308. In some examples, the characteristic derivation module 306 derives certain characteristics (e.g., profile characteristics, user preferences, behavior characteristics, and social network characteristics) based on the data input to the characteristic extraction engine. For instance, in the case of user profiles or user preferences, the characteristic derivation module 306 may derive one or more profile characteristics from the information included in a user's profile or a user's preferences. Additional user characteristics, such as behavior and social network, may also be derived in this way. Similarly, the data retrieval module 308 may utilize information input to the characteristic extraction engine 300 to formulate a query that is communicated to an external data source 310. As such, the data retrieval module 308 of the characteristic extraction engine 300 can retrieve various profile characteristics from one or more external data sources, such that these retrieved profile characteristics can be used to determine the similarity of any two user profiles.

In addition to deriving various characteristics, and retrieving various characteristics, the characteristic extraction engine 300 can include logic to normalize or standardize certain characteristics, such as profile characteristics. For instance, in some examples, a user may be prompted to provide his or her job title. Because job titles can vary from one company to the next, and from one industry to the next, job titles may be normalized or standardized. For example, the simple job title, “analyst” may have very different meanings in different industries. By normalizing and/or standardizing the job titles and then writing the standardized and normalized job titles to each user's enhanced characteristics, the recommendation engine can make meaningful comparisons, and thereby provide relatively accurate results when presenting user profiles similar to a job profile.

After the characteristic extraction engine 300 has generated the pre-processed user characteristic data 210, the matching engine 302 is able to process client requests to identify user characteristics (and/or user preferences) similar to a job profile. In some examples, the client of the matching engine 302 may simply be a server-side application that is requesting the information from the matching engine 302. Accordingly, the requesting application may specify or determine the particular configuration file that is to be used by the matching engine 302 to perform the requested task and achieve the requested objective. When a request is received at the matching engine 302 to provide a list of user characteristics similar to a job profile, the matching engine 302 can use the profile matching configuration file 304 to determine the particular user characteristics that are to be retrieved from the various enhanced user profiles. In addition, in various examples, the profile matching configuration file 304 can specify the exact comparisons that are to be performed, and how the overall matching score is to be calculated. Accordingly, the particular profile matching configuration file 304 can include instructions or directives for use by the matching engine 302 to perform the necessary characteristic comparisons, and to generate the aggregate job scores for each user profile, such that the aggregate job score for each user characteristic data indicates the similarity of the user characteristics with respect to the job profile.

In some examples, the matching engine 302 can compare multiple individual characteristics such that each compared characteristic results in an aggregate job score (referred to herein as a sub-score, to reflect that the sub-score is a component of the overall aggregate job score). Once each sub-score is determined, the sub-scores are combined in some manner indicated by the profile matching configuration file 304. That is, the profile matching configuration file 304 may dictate how the matching engine 302 is to weigh and combine the individual similarity sub-scores to derive the overall aggregate job score for various user characteristics.

FIG. 4 is a detailed example of the social network server 104. The social network server 104 includes a sponsored recommendation engine 400. The recommendation engine 400 can incorporate the recommendation engine 200 or can be an adapted form of the recommendation engine 200. In various examples, the recommendation engine 400 includes characteristic comparison capabilities between user characteristics (and/or user preferences) and job profiles.

The server 104 can include a job poster interface 402, such as with a user interface coupled to the server 104 or via the network interface 106. The user interface can include a conventional keyboard and display configuration well known in the art. The job poster interface 402 provides an interface for the posting of jobs, including a corresponding job profile, on the social network.

The job poster interface 402 is coupled to a data management system 404. The data management system 404 can incorporate data management technologies well known in the art or can incorporate proprietary data management structures. In an example, the data management system 404 incorporates SAS, or Statistical Analysis System data management systems, to promote business analysis, statistical analysis, data storage and recovery, and the like for job information. The data management system 404 can include the capacity for social network administrators to utilize the data generated by the data management system 404, such as by inputting tasks into the data management system 404.

The job poster interface 402 and the data management system 404 can both be coupled to the database 208. The job poster interface 402 can transmit job data, such as job profiles, to the database 208 for storage without respect to data management activities. The data management system 404 can store job data in the database 208 upon the job data having been acted upon for data management analysis.

The network interface 106 can provide the input of user data, such as user characteristics, into the social network. The user characteristics can be stored in the database 208 or can be directly transmitted to the recommendation engine 400 for cross reference against the job profiles stored in the database 208. Jobs identified by the recommendation engine 400 can be transmitted via the network interface 106 to the user device 102 for presentation to the user.

A job analytics system 406 can track the occurrence of jobs that have been presented to or selected by a user. The job analytics system 406 can track how many times a job has been presented, how many times a job has been selected or “clicked” on by a user, bill a job presenting entity accordingly, and adjust the remaining number of times the job has left to be presented or selected accordingly.

The job analytics system 406 can further monitor which jobs are posted to users to seek to prevent job postings from being duplicated to a single user, as well as record analytical information related to the number of times, for instance, that a presented job has been clicked on by a user and the user characteristics of users who have clicked on job presentations. In various embodiments, the job analytics system 406 can present the same job to the same user a predetermined number of times or until the user clicks on the job to learn more. The job analytics system 406 can further terminate job bids that, for instance, meet a termination date or are being presented to users unsatisfactorily frequently or unsuccessfully. Additionally, the job analytics system 406 may be utilized to renew or extend job bids, such as at the direction of the job presenting entity or the social network administrator.

In various examples, the database 208 incorporates multiple job profiles, each of the job profiles individually corresponding to one job for which an entity that has a corresponding job to offer. The recommendation engine 400 is configured to determine an aggregate job score for at least some of the job profiles in the database 208 by incorporating a relevance of the job profiles to user characteristics using the recommendation engine 400 and a potential job bid corresponding to each job profile.

In various examples, when a user accesses the social network, the recommendation engine 400 cross references the user's characteristics (and/or the user's preferences) against some or all of the job profiles in the database 208. The recommendation engine 400 can generate a relevance for each of the cross referenced profiles. The recommendation engine 400 can utilize a processor 408 (in various examples, the processor 408 is the processor 112 of the system 100) can manipulate the relevance for the job profile. In various examples, any combining mechanism or process can be utilized to produce the aggregate job score.

In various examples, the relevance of a job profile to a user may factor in previous success that the job posting has had with other users. If a large percentage of users who are presented with a job posting based on the job profile select the job posting for more information, then the job posting may be deemed more relevant. A so-called “click-through rate” that exceeds a threshold may result in the relevance of the job posting being increased, while a click-through rate less than a threshold may result in the relevance of the job posting being reduced.

Relatedly, the characteristics of other users of the social network who do select a job posting for more information can also be incorporated into determining the relevance for a particular user. Characteristics of users who have selected a particular job posting in the past can be compared against user characteristics (and/or user preferences) of a prospective user. To the extent that user characteristics of a prospective user are or are not related to the user characteristics of users who have selected a job posting in the past, the relevance of the job posting may similarly be increased or decreased for a prospective user. As such, the server 104 may store characteristics of users who have selected the job posting in the past and may develop composite user characteristics. The degree to which the characteristics of a prospective user match the composite characteristics may weigh the results of the recommendation engine more heavily for a given prospective user.

In various examples, the recommendation engine 400 does not present a job to a user unless the relevance of the job profile to the user characteristics (and/or user preferences) is greater than a minimum threshold. In such examples, it may be undesirable to display jobs that are unsuitable to a particular user to that user.

FIG. 5 is a depiction of a user interface screen 500 that can be displayed by the social network on the user device 102 corresponding to a user. In an example, the user interface screen 500 is a sub-portion of a larger user interface screen displaying additional information related to the social network. Upon the recommendation engine 400 having identified jobs to present to a user, the social network server 104 can transmit the jobs to the user device 102, such as along with other social network information that is displayed on a user interface, such as a display screen, of the user device 102.

In the illustrated example, the user interface screen 500 includes a list 502 of jobs. In various examples, the list 502 is an ordered list based on various criteria described herein.

In an example noted above, jobs 504A and 504B are displayed at the top of the list, i.e., most prominently on the list 502. In the illustrated example, the jobs 504A and 504B include a job title 506, a job category 508, and a job location 510.

In the illustrated example, jobs 514A and 514B are displayed less prominently than the jobs 504A and 504B. The jobs 514A and 514B include the job title 506, the job category 508, and the job location 510.

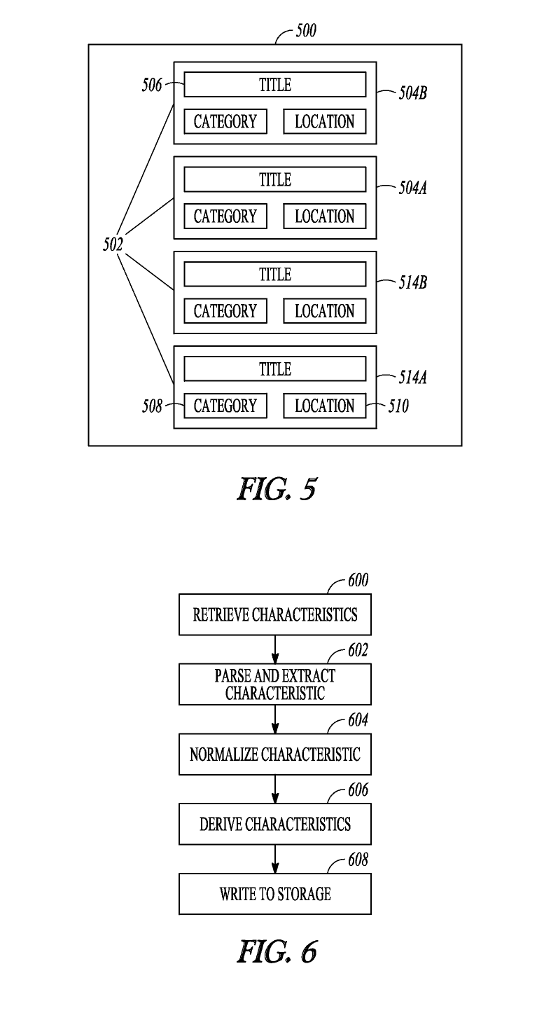

FIG. 6 is a flow diagram illustrating an example of the method operations involved in a method of pre-processing user characteristics (and/or user preferences) with a characteristic extraction engine to generate enhanced characteristics for use by a matching engine. In some examples, some of the method operations illustrated in FIG. 6 may be performed offline by means of a batch process that is performed periodically (e.g., two times a day, daily, weekly, and so forth), while in other examples, the method operations may be performed online and in real-time as requests for similar user characteristics and job profiles are being received and processed.

At 600, the relevant characteristics (and/or preferences) for a user or job profile are retrieved. In some examples, the characteristic extraction engine is configured to extract only certain characteristics from each user's characteristics information. Accordingly, the characteristic extraction engine may simply retrieve from a database the relevant data corresponding to the relevant characteristics. In some examples, the retrieval may be performing a database look-up or fetch of the relevant data.

At 602, as some profile characteristics may be free-form text (i.e., unstructured data), such as a description of a user's interest, skills, hobbies, career objectives, and so forth, some of the relevant characteristics that have been retrieved are parsed and extracted from their raw data format.

At 604, one or more processes may be performed to either normalize or standardize one or more profile characteristics. For instance, a user's job title may be standardized so that it can be more easily compared with others. Similarly, the name of a company that employs a user may be normalized, for example, to drop or add “Inc.” or “Corporation” and so forth.

At 606, the characteristic extraction engine 300 may derive one or more characteristics from raw data included in a user's or job's profile. For example, in some examples, one or more enhanced characteristics may be characteristics that are derived from the raw data included in a user's characteristics (or user's preferences). If, for example, a user's profile indicates the year that he or she graduated from college, an enhanced characteristic that can be derived from this raw data may include the number of years of work experience after college. In addition, some characteristics may include data received from a data source external to the system 100. Accordingly, data from a user's profile (e.g., a name, or other identifying data) may be used to query an external data source for additional information about the user.

At 608, the relevant characteristics, including characteristics such as extracted characteristics, derived characteristics, normalized or standardized characteristics, or retrieved characteristics are written to storage as pre-processed, enhanced user characteristics.

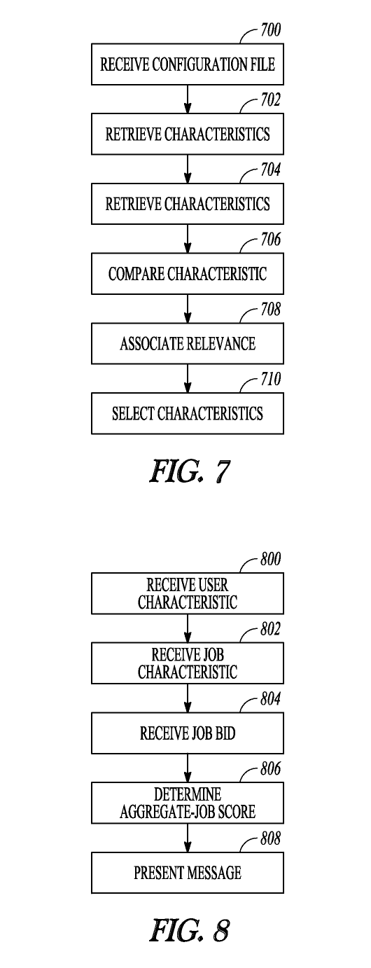

FIG. 7 is a flow diagram illustrating an example of the method operations involved in a method of determining the relevance between user characteristics and a job profile with a matching engine 302.

At 700, the recommendation engine 200 receives, retrieves, or otherwise reads or processes a profile matching configuration file. The profile matching configuration file, which may be a document formatted in Extensible Mark-up Language (XML) or in some other format, specifies the particular characteristics (or data elements) that are to be extracted or retrieved from a particular recommendation entity, such as enhanced user characteristics (and/or enhanced user preferences). For example, in assessing the relevance of user characteristics to a job profile, the names of the person and the job may not play a role in determining the similarity of the profiles. As such, the profile matching configuration file may not include user's names as a characteristic to be extracted and compared. However, technical skills or professional organizations may be relevant to the analysis, and as such, these characteristics may be specified in the profile matching configuration file, such that the data representing these characteristics are ultimately retrieved and analyzed by the matching engine 302.

As discussed below, the profile matching configuration file specifies the particular characteristics to be retrieved as well as the particular matching algorithms to be used for each of the retrieved characteristics. For example, the profile matching configuration file indicates an algorithm or comparison operations that are to be performed for the various characteristics specified in the matching configuration file, and how the various similarity sub-scores, resulting from the comparison of individual characteristics, are to be combined to generate an overall relevance. In some instances, the profile matching configuration file may indicate that a particular comparison is to be performed for a particular characteristic that results in a match only when there is an exact match. In other instances, a partial match may be indicated, and so forth. In some instances, the comparison may involve determining whether a particular user characteristic is within a particular distance of the same job profile characteristic and so forth. As such, the matching profile may indicate not only the type of matching operation to be performed between a particular pair of characteristics, but also the weight that should be applied to any resulting sub-score generated as a result of a match occurring between two characteristics. In some examples, the weight applied to any particular sub-score may be dependent upon the extent to which two characteristics match, as specified by a matching algorithm or rule in the profile matching configuration file.

At 702, the relevant characteristics for one of the user characteristics (and/or user preferences) and the job profile are retrieved. In some instances, the job profile may be selected by a user, while in other instances, an application or process selects a particular job profile. In any case, the relevant job profile characteristics for the selected job profile are those job profile characteristics specified in the profile matching configuration file obtained at 700. In some examples, each user and job profile may have an identifier (e.g., such as a user or job identifier, or, user or job profile identifier). Accordingly, a request to identify job profiles similar to user characteristics may include an identifier identifying the job profile. With this, the matching engine 302 can retrieve the necessary characteristics from the pre-processed, enhanced user or job profile for the particular user or job identified by the user or job identifier, as the case may be.

At 704, the matching engine retrieves the same set of characteristics for the other of the user characteristics (and/or user preferences) or job profile not retrieved at 702. In some examples, the particular user or job profiles that are compared may be selected based on some required matching criteria, either by default, or as specified by an application, process or user who has initiated the request. For instance, the matching analysis may be limited to only those users or jobs that share a particular characteristic in common with the profile selected in 702, such as having the same job title, or experience requirement. In other instances, the entire set of user characteristics or job profiles may be considered.

At 706, the matching engine 302 compares the various characteristics and calculates the relevance for the user characteristics (and/or user preferences) and the job profile in accordance with the instructions or directives set forth in the profile matching configuration file. For instance, the profile matching configuration file indicates what comparison operation is to be performed for a pair of characteristics, and how the various similarity sub-scores are to be combined to derive the overall aggregate job score.

At 708, the relevance is associated with the user characteristics (and/or the user preferences). The process of operation 706 may be repeated for additional job profiles, until all of a particular set of job profiles have been assigned relevance scores.

At 710, once all the job profiles have a relevance score, indicating a level of similarity to the user characteristics (and/or the user preferences), a certain number of the job profiles with the highest aggregate job scores are selected for use with the recommendation engine 400. In some examples, the number of job profiles that are selected and provided for use with a requesting application may be determined using some default or predetermined number. Alternatively, in some examples, the number of user characteristics that are selected and provided to a particular requesting application may be configurable so that a certain number of the user characteristics with the highest relevance scores are provided. For example, in some examples, the profile matching configuration file specifies the number of user characteristics that are to be returned to the requesting application. The number of user characteristics may be specified explicitly (e.g., ten, thirty, one-hundred), or via a rule, such as, the top “X” number of user characteristics, or all user characteristics with a matching score exceeding “X”, or some combination.

FIG. 8 is a flowchart for presenting a message relating to a job to a user or member of an online social networking service based on an aggregate job score. The flowchart is discussed herein with respect to the system 100, but can be implemented on any suitable system.

At 800, a user characteristic (and/or user preference) is received by the processor 112. In various examples, multiple user characteristics are received by the processor 112. The user characteristic can be received via network interface 106, can be obtained from the electronic data storage 110 of the system 100, or can be received as input from a direct physical connection to the system 100, among other possible input methodologies known in the art.

At 802, a job characteristic of a job profile of a job is received by the processor 112. In various examples, multiple job characteristics of the job profile are received by the processor 112. The job characteristic can be received via the job poster interface 402, such as via the network interface 106, from the electronic data storage 110 of the system, or can be received as input from a direct physical connection to the system 100, among other possible input methodologies known in the art. In various examples, job characteristics from multiple job profiles can be received.

At 804, a job bid is received from an entity related to the job, such as a job posting entity that posted the job to the social network. In various examples, the job bid can include a monetary bid for a number of times a message related to the job is posted on a user device 102, a number of times a user selects or “clicks” on the message, an amount of money the job posting entity is willing to pay for each time a job message is presented, selected, or otherwise interacted with, a total amount of money the job posting entity is willing to pay, a duration of time the bid is active, and so forth as disclosed herein. In various examples, multiple job bids from multiple jobs can be received.

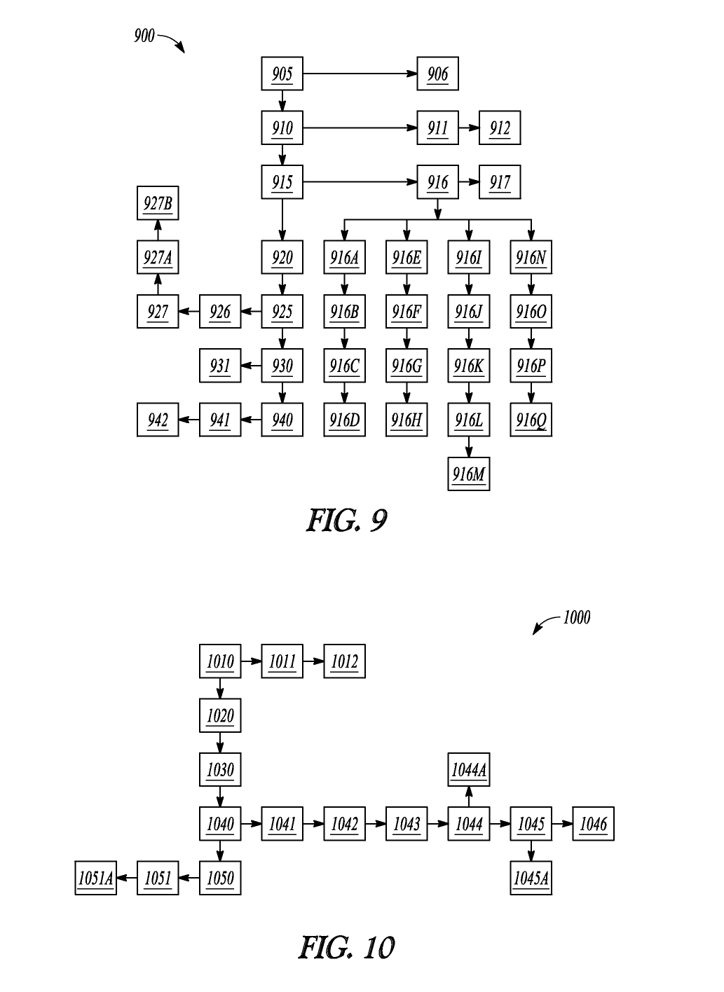

At 806, the processor 112 determines an aggregate job score for the user or member based on the relevance of the job characteristic to the user characteristic (and/or user preference) and the job bid. The relevance can be determined according to the methodology of FIG. 9 and as disclosed herein. Relevance can be determined as a percentage of matching ones of the user and job characteristics that comprise the user and job profiles, respectively. The aggregate job score can be arrived at by applying the bid to the relevance. In various examples, the relevance is multiplied by the bid to arrive at the aggregate job score.

At 808, a message relating to the job is presented to the user based, at least in part, on the aggregate job score. In various examples, the message is presented as illustrated on the interface screen 500. In various embodiments, the message includes an internet web link to further information. As shown on the interface screen 500, presentation of the message related to the job can be organized on the interface screen 500 as an ordered list according to which job has the largest aggregate job score. In various examples, multiple messages related to different jobs are presented with respect to one another based on their respective aggregate job scores, such as by placing higher magnitude aggregate job scores relatively more prominently on the interface screen 500. In various examples, only jobs that have relevance with a magnitude greater than a predetermined threshold are presented to the user.

FIG. 9 is a block diagram illustrating operations and features of a system and method for permitting a user or member of an online social networking service to create a modified profile for use in connection with a job posting service. FIG. 9 includes a number of feature blocks and operation blocks 905-942. Each block of FIG. 9 includes a reference number that corresponds to a reference number in the following paragraphs. Verbal descriptions are not included in the blocks of FIG. 9 in order to increase the readability of FIG. 9. Though arranged substantially serially in the example of FIG. 9, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 9, at 905, an online social networking service maintains a member characteristic of a member. The term online social networking service includes online business networking services. In some situations, the term member refers to a person who is a registered user of the online social networking service and who has a member profile associated with the online social networking service. A user of the online social networking service may not be registered with the online social networking service, but still uses the service. In other situations, a user may be a registered user and have a profile associated with the online social networking service. The member characteristic can be part of a member profile of the online social networking service (906).

At 910, a job characteristic of a posted job profile is maintained. The posted job can be posted via a job posting service, or as indicated at 911, the posted job can be posted by the online networking service. At 912, the job profile of a posted job is saved to a computer storage device associated with the online social networking service. At 915, the online social networking service receives an input from the member to modify the member characteristic. The modification of the member characteristic can be executed by the profile modification engine 207. Examples of member characteristics that a member can modify include geographic location, job position or title, company size, and an industry (916). At 917, the modified member characteristic is stored as a member preference in connection with the online social networking service. At 920, the online social networking service compares the modified member characteristic with the job characteristic. At 925, the online social networking service transmits a message to the member based on the comparison of the modified member characteristic with the job characteristic.

These features allow a member of an online social networking service to search for and/or be contacted for available positions that do not entirely match up with the member's profile or member characteristics. For example, if the member's profile indicates that the member is currently living in a particular geographic location, but the member wants to relocate to a different geographic location, the member can indicate such a preference by altering his or her member characteristics. In this manner, the online social networking service will not limit the member to his or her current geographic location (contained in the member's profile or characteristics) when comparing current employment positions with the member's profile. As another example, the member may currently work for an established, relatively large company, but the member may now be interested in working for a smaller startup company. The member can modify his or her member characteristics to reflect this desire. These modified member characteristics can be stored as user preferences.

Blocks 916A through 916Q illustrate additional features of the online social networking service in connection with modifying member characteristics such as geographic location, job position, job title, company size, and industry.

Referring to blocks 916A through 916D, the online social networking service defaults the geographic location to a geographic location stored in the profile of the member (916A). This is the normal or typical state of the service prior to a member modifying any of his or her member characteristics. At 916B, the online social networking service displays a user interface to the member. At 916C, the online social networking service receives via the user interface a new geographic location from the member. This new geographic location is different from the geographic location that is currently in the member's profile (which may have been extracted from the member's residential address or business address). At 916D, the online social networking service sets the geographic location in a member preference to the new geographic location entered by the member. The online social networking service can also store in the member preference a geographic area that is associated with or related to the new geographic location that was entered by the member. In this manner, while a member may enter San Francisco as the geographic area, the online social networking service can create a member preference that includes the greater San Francisco Bay Area.

Referring to blocks 916E through 916H, at 916E, the online social networking system defaults the job position and title to a job position and title stored in the profile of the member. At 916F, the online social networking system displays a user interface to the member, and at 916G, the online social networking service receives a new job position and title from the member via the user interface. At 916H, the online social networking system stores the new job position and title entered by the member in a member preference. This feature permits a member to search and/or be considered for posted job positions that are outside of the types of job positions in his or her member profile.

Referring to blocks 916I through 916M, at 916I, the online social networking system defaults to all company sizes. Consequently, when the online social networking service compares the member's characteristics to job postings, companies of all sizes will be considered for the member. In an alternative embodiment, the member's characteristics will contain a company size that is comparable to the current company with which the member is employed. At 916J, the online social networking service displays a user interface, and at 916K, the online social networking service receives a selection of a company size from the member. At 916L, the online social networking service stores the selection of the company size in a member preference. As indicated at 916M, the user interface can be a slider bar, wherein the slider bar presents to the member on the user interface a range of company sizes for selection by the member and subsequent storage in the member's preference.

Referring to blocks 916N through 916Q, at 916N, the online social networking system defaults the industry to an industry stored in the profile of the member. Consequently, when the online social networking service compares the member's characteristics to job postings, job postings in the member's current profile will be considered for the member. At 916O, the online social networking service displays a user interface to the member, and at 916P, the online social networking service receives a selection of a new industry from the member. At 916Q, the online social networking service stores the selection of the new industry from the member in a member preference. This preferred industry of the member can now be used when comparing the member to posted job listings.

At 930, the online social networking service determines that the member has never modified the member characteristic. In such a situation, at 931, the online social network service displays a user interface permitting the member to modify the member characteristic.

In a similar manner, at 940, the online social networking service determines a date on which the member last modified the member characteristic. At 941, the online social networking service compares the date to a threshold date. When the date is prior to the threshold date, then at 942, the online social networking service displays a user interface to the member permitting the member to modify the member characteristic.

At 926, the online social networking system transmits the message relating to the comparison of the modified member characteristic and the job characteristic to the member on a periodic basis. That is, in an embodiment, the online social networking system is continuously searching for job positions for a member, and whenever such positions are located, information relating to those positions is transmitted to the member. At 927, the message transmitted to the member includes a page associated with the online social networking service. The page can include an icon identifying a company with an employment position and a link to information relating to the employment position. At 927A, the online social networking service permits the member to hide or discard a displayed employment position, and at 927B, the online social networking system permits the member to undo a decision to hide or discard the displayed employment position.

FIG. 10 is a block diagram illustrating operations and features of a system and method that determines whether an employer would be interested in a particular person for employment, and if that employer is interested, notifying the person of the employer's interest. In an embodiment, the checking with the employer is done without the knowledge of the person, and results in the person being informed of an employer that is interested in the person. FIG. 10 includes a number of feature blocks and operation blocks 1010-1051A. Each block of FIG. 10 includes a reference number that corresponds to a reference number in the following paragraphs. Verbal descriptions are not included in the blocks of FIG. 10 in order to increase the readability of FIG. 10. Though arranged substantially serially in the example of FIG. 10, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

More specifically, FIG. 10 illustrates a flow diagram of an embodiment that automatically recommends employment positions to a user or member of an online social network service. The online social network service compares a member profile to the requirements of an available employment position, and if there is a match, the online social networking service transmits the member profile to the employer. If the employer would like to explore employment opportunities with this member, then the employer informs the online social networking service, and the online social networking service in turn informs the member. In contrast to a system that may compare a member's credentials to an available employment position and suggest one or more jobs to the member, this embodiment automatically (with or without member's permission) transmits the member's profile to the employer. That is, when the online social networking service sends the member's profile to the employer, the member has basically automatically already passed the “resume filter” in connection with this available employment position (that is, the member has been “pre-cleared” for the next step in seeking this available employment position), and this current available employment position may not be simply a job that the member may be interest in, but a job that is interested in the member.

Referring specifically now to FIG. 10, at 1010, a profile of a person is maintained in a computer database. As indicated at 1011, the database and profile can be associated with an online social networking service. The profile can be of a member of the online social networking service. A member of an online social networking service can be a person who is a registered user of the online social networking service, and for whom the online social networking service maintains a profile. In another embodiment, a non-member or non-registered user could also benefit from the automatic job matching capabilities of this embodiment, as long as the user provides personal, education, and employment history information to the online social networking service. At 1012, it is noted that the profile of the user or member can include a work history, an education history, a social connections history, and a business connections history. As such, the term online social networking service includes purely social network services, purely business network services, and hybrids of social networking services and business networking services.

At 1020, the online social networking service receives from an employer requirements for a particular employment position that the employer is trying to fill. In an embodiment, these employment position requirements can be entered by the employer via the user interface module 202, and stored as data 210 in the database 208. The employer may or may not be a user-entity or member-entity of the online social networking service.

At 1030, the recommendation engine 200 compares the profile of the member to the requirements for the employment position. These employment position requirements can include, for example, education requirements, work experience requirements, technical expertise requirements, and geographic requirements. At 1040, the recommendation engine determines if there is a match between the requirements of the employment position and the profile of the member. The degree of match between the employment requirements and the member profile can be programmed per the desires of the employer. For example, the employer may require that there is a match between the requirements and the member in all of the categories of the requirements. When the profile of the person matches or exceeds the requirements for the employment position, the recommendation engine 200 transmits a message to the employer containing the profile of the person.

At 1041, the online social networking service seeks permission from the member before sending the member's profile to the employer. In this embodiment, the transmission of the member profile to the employer is not automatic. Rather, the member must first opt in to the service of having his or her profile sent to an employer when his or her profile matches with the requirements of an open employment position. This embodiment can be directed to an active job seeker, that is, one who is currently and actively seeking a new employment position. That is, the member is informing the online social networking service that he or she is actively looking for a new employment position.

At 1042, the online social networking service transmits the message to the employer containing the profile of the person without receiving permission from the person. This embodiment can be directed more to a passive job seeker. That is, a member who is not really actively looking for a new job, but one who would consider a new opportunity if presented with one.

At 1043, an embodiment relates to a feature wherein the online social networking service conceals the identity of the member prior to transmitting the message to the employer. The member may prefer this embodiment, irrespective of whether the member is an active job seeker (1042) or a passive job seeker (1041).

At 1044, an embodiment relates to a feature wherein the online social networking service inquiries, before sending the member's profile to an employer, whether or not the member would like his or her profile sent to a particular employer. If the member provides permission to the online social networking service to send his or her profile to the employer, the online social networking service transmits the member's profile to the employer. If the member does not provide permission, the member's profile is not sent to the employer. This embodiment allows the member to approve/prevent the sending of his or her profile to employers on an employer by employer basis. In this manner, if there is a particular employer for whom the member would not like to work, then this feature prevents the member's profile from being sent to that particular employer. At 1044A, the online social networking service provides the option to the member of having the member's identity revealed to the particular employer. In this embodiment, the member may be extremely interested in a particular employer and/or a particular employment position, and he or she may feel that revealing his or her identity to the employer may exhibit that interest to the employer.

At 1045, the online social networking service transmits a message to the member indicating that his or her profile matched or exceeded the requirements of the open employment position. Then, at 1045A, the online social networking service will provide the profile of the member to the employer within a certain time period after transmitting the message to the member that indicates the matching or exceeding of the member's profile with the employment requirements, unless the person indicates within the certain time period to refrain from transmitting the profile of the person to the employer.

At 1046, prior to the comparison of the profile of the member to the requirements for the employment position, the online social networking service normalizes the data in the member's profile and normalizes the data in the requirements for the employment position. This normalization permits a more accurate comparison between the member profile and the employment requirements. For example, a member may list “web site development” as a skill, and the employment position requirements may be seeking a “web designer.” The online social networking services can normalize both of these to “web design and development,” and as normalized the member would match this particular employment requirement.

At 1050, the online social networking service receives a response from the employer regarding the member and the open employment position. If the employer exhibits an interest in the person for the employment position, then at 1051, the online social networking service transmits a message to the member informing the member of the employer's interest. At 1051A, the online social networking service conceals the identity of the employer prior to transmitting the message to the member indicating the interest of the employer in the person. This feature can be invoked at the request of the employer.

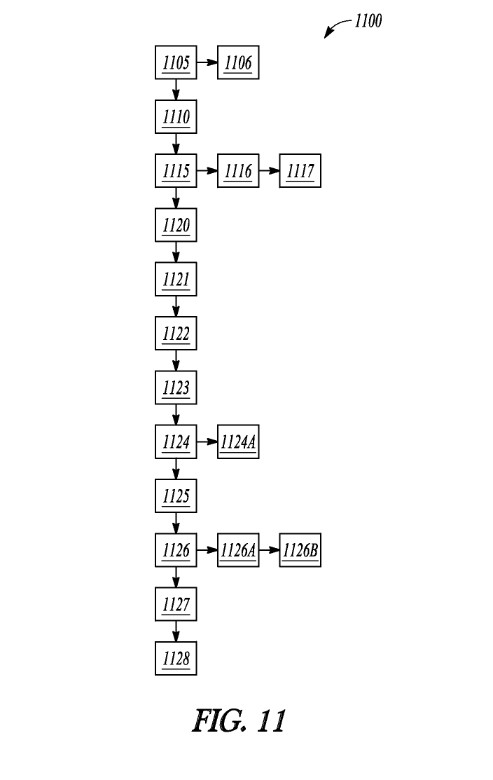

FIG. 11 is a block diagram illustrating an embodiment that ranks a member of an online social network against others in connection with a current job posting. FIG. 11 includes a number of feature blocks and operation blocks 1105-1128. Each block of FIG. 11 includes a reference number that corresponds to a reference number in the following paragraphs. Verbal descriptions are not included in the blocks of FIG. 11 in order to increase the readability of FIG. 11. Though arranged substantially serially in the example of FIG. 11, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Specifically, at 1105, an online social networking service receives a message from a member of the online social networking service indicating an interest in applying for an employment position. As with other embodiments noted herein, this embodiment can also function with a user of the online social network who is not a registered member of the online social networking service. For example, a non-member user can enter a profile that can be used in connection with analyzing current job postings for the user. In another embodiment, the member does not actively indicate an interest in the employment position, but rather the online social networking service automatically compares the member's profile to a current job posting. As indicated at 1106, in an embodiment, the employment position is posted in connection with the online social networking service (instead of a separate job posting service), and the profile of the member and profiles of other members are stored in connection with the online social networking service.

At 1110, the online social networking service compares a profile of the member against one or more requirements for the employment position, one or more members of the online social networking service currently employed in the employment position, and profiles of other members who have indicated an interest in the employment position.

At 1115, the online social networking service computes a rank of the member based on the comparison of the profile of the member to the requirements for the employment position, the comparison of the profile of the member to the one or more members currently employed in the employment position, or the comparison of the profile of the member to the profiles of other members. In an embodiment, the computation of a rank can include a determination of the number of requirements of the employment position that the member meets or exceeds. For example, if the member meets 8 out of 10 requirements for an employment position, the member will be ranked higher than a person who only meets 6 out of the 10 requirements. The computation of the rank can further include a determination that member exceeds the number of years of work experience of other members who are currently employed in the employment position (or other members who are seeking this employment position). In such an instance, the member will be ranked higher as compared to others. Those of skill in the art will realize that the rank can be computed in other ways. Additionally, certain means of computation can be weighted more heavily than others. For example, more weight may be applied to a computation that determines that a member exceeds the skills of those currently in the employment position rather than a member who exceeds the skills of other members who are interested in the employment position. The rank can be computed by the candidate ranking engine 206.

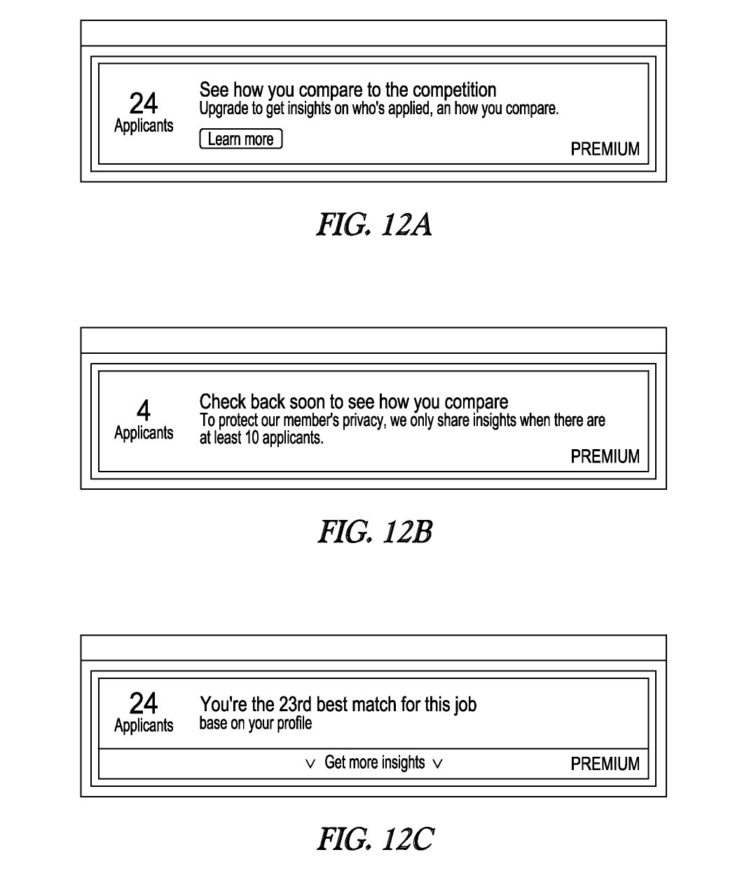

At 1116, the online social networking service computes the rank of the member who has exhibited an interest in the employment position compared to the other members who have exhibited an interest in the employment position only when the number of the other members is greater than a threshold. For example, the online social networking service may require that there be at least 10 applicants for a posted job before a ranking is calculated. A reason for this requirement may be that a more accurate ranking will be generated in connection with a larger sample size. For example, if there are only two applicants, the member may be ranked as number 1 compared to the other applicant. However, after ten more applicants show an interest in the employment position, if those ten applicants rank higher than the member, then the member's rank will drop from number 1 to number 11. The minimum number of applicants requirement prevents a misleading initial estimate being supplied to the member, and such a subsequent precipitous drop being reported to the member. Additionally, the minimum number of applicants requirement helps to protect users' privacy. FIG. 12B illustrates an example user interface reporting that there are not enough applicants at the current time to rank the member.

In another embodiment, as indicated at 1117, the rank of the member compared to the other members is based at least in part on the input of a recruiter for the employment position. For example, if there is something in the profile of the member that is difficult to rank based on artificial and/or machine intelligence, then the recruiter can provide input to the ranking mechanism that can be used in the calculation of the rank for the user. For example, if an interest in charitable work is considered a positive aspect for employment at the company, a recruiter can more easily apprise a listing of several charitable organizations in the member profile more so than a machine algorithm.

At 1120, the online social networking service transmits a message to the member regarding the rank of the member. As noted above, this ranking is a ranking against all other members (or users) of the online social networking service who have exhibited an interest in the employment position or have otherwise been considered for the employment position (for example, via automatic means). FIG. 12C illustrates an example user interface that can be used to report the ranking to the member.

In an embodiment, as indicated at 1121, the online social networking service can require that a fee be paid by the member prior to providing the rank of the member to the member. FIG. 12A illustrates an example user interface that can be displayed to the member informing the member of this ranking feature. If the member is interested in this feature, the member can click on the “Learn more” icon to learn more about this feature and to enroll and receive this feature.

In an embodiment, as indicated at 1122, the online social networking service anonymously displays the profiles of the other members to the member. This feature permits the member to see how his education, work experience, and skills levels compare to other members who have exhibited an interest in the employment position. In turn, this will provide an indication to the member of his or her chances of being further considered and/or selected for the employment position.

In an embodiment, as indicated at 1123, the online social networking service reports the rank of the member compared to the other members by placing the member into one of a plurality of buckets. Each of the buckets includes a number of the members who fall within the range associated with that particular bucket.

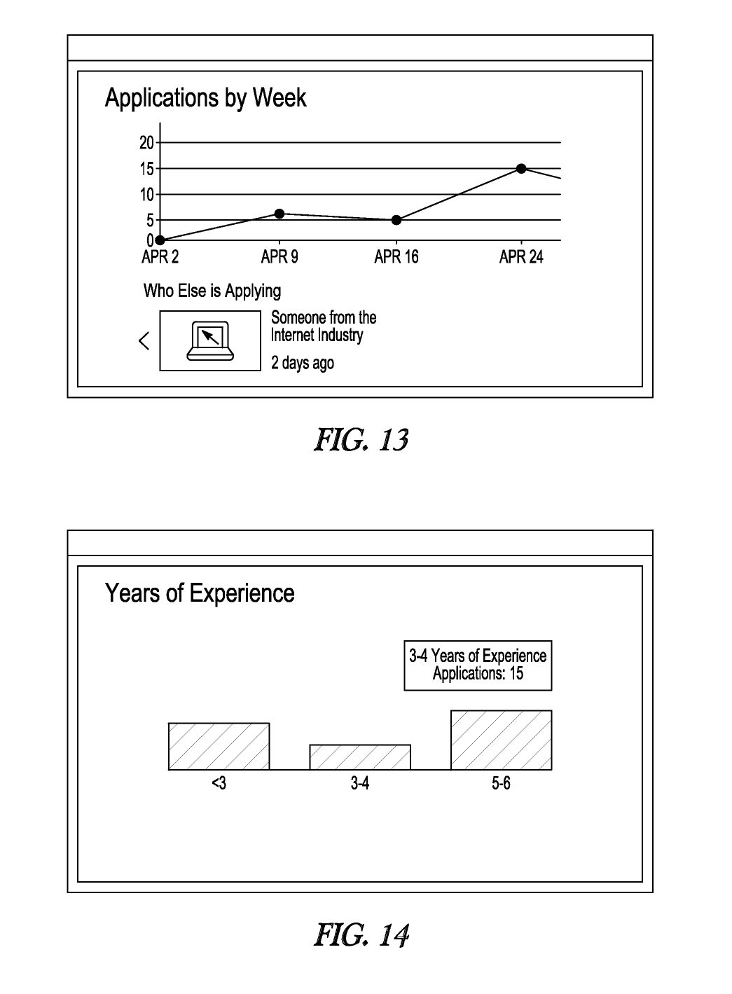

In an embodiment, as indicated at 1124, the online social networking service displays to the member on a computer display unit a number of the other members who have indicated an interest in the employment position. At 1124A, the display on the computer display unit of the number of other members who have indicated an interest in the employment position is categorized by a date when the other members indicated an interest in the employment position. FIG. 13 illustrates an example user interface that can be used to report to a member the number of other members who are interested in the employment position. The interface of FIG. 13 reports on a week by week basis the number of applicants for the employment position, and in an embodiment further indicates the company with whom one or more of those other members are associated.

In an embodiment, as indicated at 1125, the online social networking service displays a bar graph on a computer display unit. The bar graph indicates the number of other members who have indicated an interest in the employment position based on the number of years of experience of the other members. An example of a user interface that can be used to implement these features is illustrated in FIG. 14. In an embodiment, when the member hovers over a bar on the bar graph, the number of members who fall into that range of experience is displayed to the member.

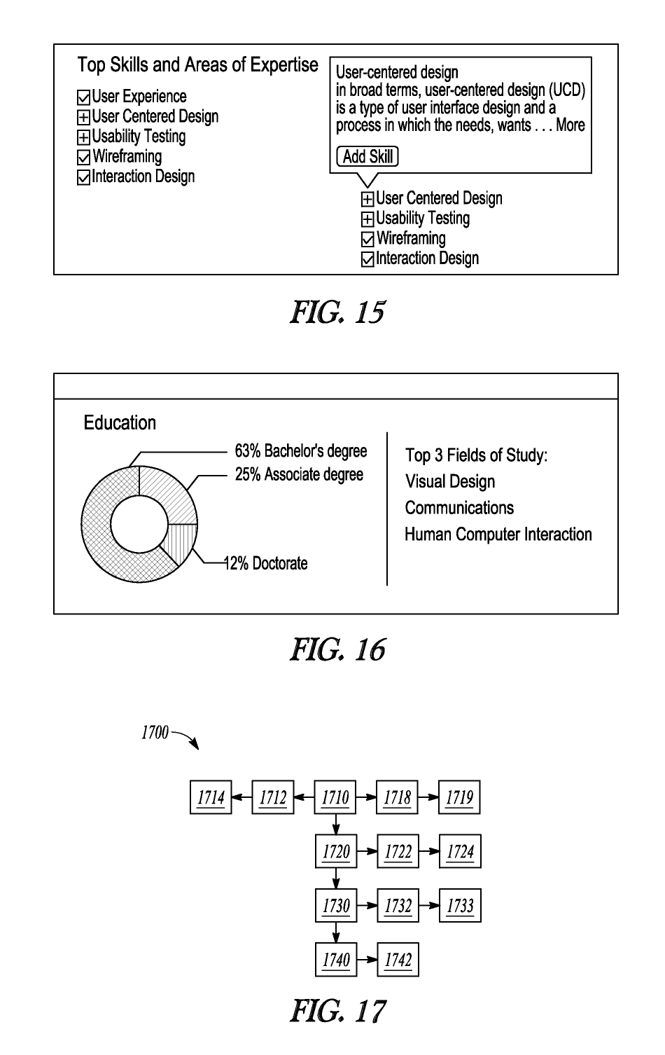

In an embodiment, as indicated at 1126, the online social networking service displays on a computer display device a list of skills associated with the other members. The online social networking service further displays an indication of the skills from the list of skills that are possessed by the member. In a further embodiment, as indicated at 1126A, the online social networking service displays to the member on a computer display unit a description of a skill on the list that is not possessed by the member. Then, at 1126B, the online social networking service can receive input from the member that adds the skill on the list that is not possessed by the member to the profile of the member. This permits a member to add a skill to his or her profile that the user possesses as determined by the description of that skill provided by the online social networking service. FIG. 15 illustrates an example user interface that can be used to implement this feature.

In an embodiment, as indicated at 1127, the online social networking service displays on a computer display unit education history data of the other members who have indicated an interest in the employment position. An example user interface that can be used to implement this feature is illustrated in FIG. 16. FIG. 16 further illustrates that the fields of study within the listed degrees can be displayed on the user interface. At 1128, the online social networking service can display the rank of the member as a color-coded bar ranging from a lower rank to a higher rank.

FIG. 17 is a block diagram illustrating an embodiment that permits a job recruiter or other individual to electronically peruse through job applicants and to take an initial action regarding those job applicants. FIG. 17 includes a number of feature blocks and operation blocks 1710-1742. Each block of FIG. 17 includes a reference number that corresponds to a reference number in the following paragraphs. Verbal descriptions are not included in the blocks of FIG. 17 in order to increase the readability of FIG. 17. Though arranged substantially serially in the example of FIG. 17, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Specifically, at 1710, a computing device such as a computer processor receives data relating to a job candidate for an employment position. Block 1712 illustrates that the data relates to a resume or a profile of a person who is associated with an online networking service. As indicated at 1714, the processor is associated with a mobile communication device of a job recruiter. The job recruiter could be an employee of a business organization who is looking for employees, or an independent recruiter who provides recruiting services to more than one business organization. At 1718, the computer processor receives input from the job candidate, and modifies the data relating to the job candidate based on the input from the job candidate. This feature permits the job candidate to update the information on his or her resume or profile. This update can be the result of a new skill or education of the job candidate, a realization by the job candidate that he or she has a skill sought by an employer that is not readily identifiable from his or her resume or profile, or some other reason for modification. Block 1719 illustrates in particular that the modification of the data relating to the job candidate relates to one or more of deleting data relating to the job candidate, adding data relating to the job candidate, and highlighting data relating to the job candidate.

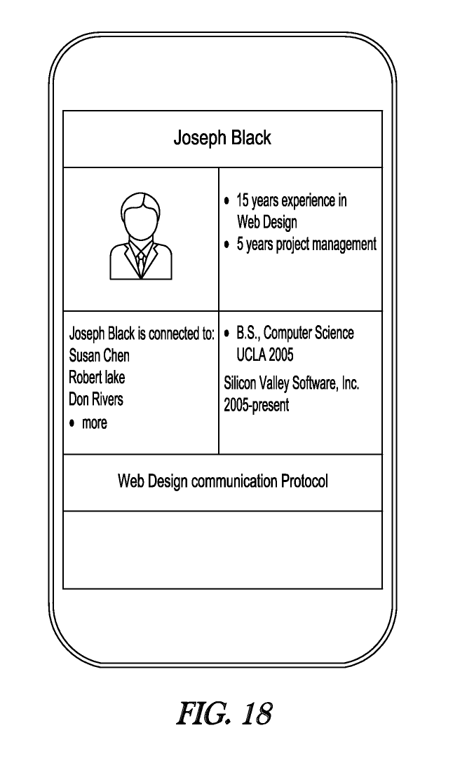

At 1720, the data relating to the job candidate is displayed on a computer display device. The computer display device includes a touch sensitive screen, and as indicated above at 1714, the computer display device can be a mobile communication device. Block 1722 illustrates that the data relating to the job candidate can include one or more icons, and further that the computer processor can receive input from a user regarding the job candidate via the one or more icons. Block 1724 further illustrates that the computer display device includes a plurality of sections or windows. The plurality of sections or windows includes a name of the job candidate, a photograph of the job candidate, a highlighted attribute of the job candidate, a social connection of the job candidate, an education history of the job candidate, an employment history of the job candidate, and a skills summary of the job candidate. FIG. 18 illustrates a screen shot of the display of a personal communications device illustrating the display of the data relating to the job candidate.

At 1730, the computer processor receives an input from a user (e.g., a job recruiter) via the touch sensitive screen. The input can be received and processed by the recruiter recommendation engine 205. The input relates to a decision on the job candidate for the employment position. Specifically, as indicated at 1732, the input or decision indicates an acceptance of the job candidate, a rejection of the job candidate, a hold or deferral of the job candidate, or a referral of the job candidate. Further, as indicated at 1733, the input from the user is a sweeping motion. In an embodiment, the computer processor interprets four sweeping motions. A sweeping motion in a first direction (e.g., to the right) indicates an acceptance of the job candidate, a sweeping motion in a second direction (e.g., to the left) indicates a rejection of the job candidate, a sweeping motion in a third direction (e.g., in the up direction) indicates a hold or deferral of the job candidate, and a sweeping direction in a fourth direction (e.g., in the down direction) indicates a referral of the job candidate to another person for that other person to consider the job candidate.

At 1740, the computer processor stores, discards, or forwards the decision or the data relating to the job candidate to another memory device based on the input from the user. The storing, discarding, and/or forwarding can be processed by the recruiter recommendation engine 205. At 1742, the computer processor ranks the job candidate compared to other job candidates based on the input of the user or job recruiter. For example, if the decision of the job recruiter is to forward the profile or resume of a person to an online social networking service or a job posting service, which rank all candidates for the employment position based on the profiles/resumes of the job candidates, the ranking of the candidate can further be influenced by the input of the job recruiter.

The embodiment of FIGS. 17 and 18 permit a recruiter to easily review many resumes and/or profiles of job candidates, and further to make an initial decision on each of these resumes or profiles. A tool that includes the features of this embodiment is an asset to a busy corporate recruiter in a competitive job market wherein the business organization wants to hire the best people and not lose the best people to competitors.

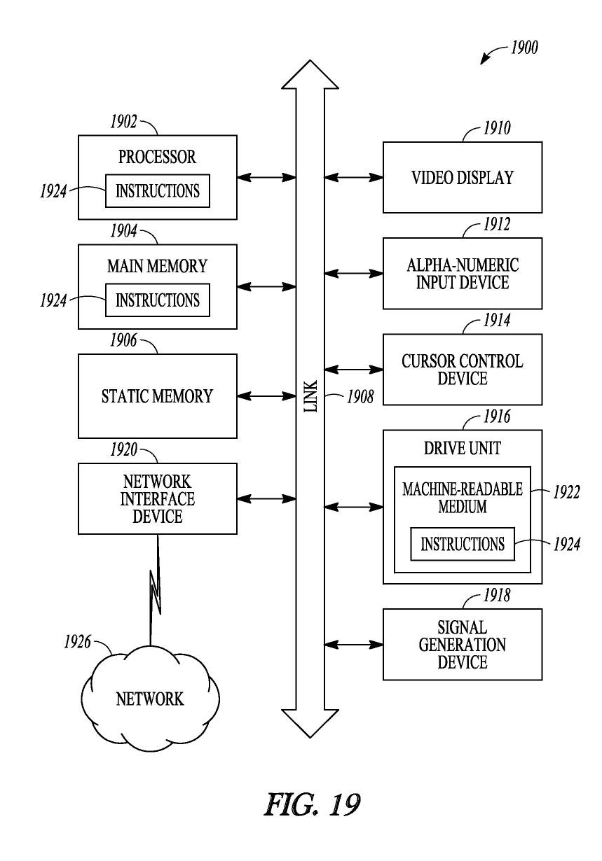

FIG. 19 is a block diagram illustrating components of a machine 1900, according to some example examples, able to read instructions from a machine-readable medium (e.g., a machine-readable storage medium) and perform any one or more of the methodologies discussed herein. Specifically, FIG. 19 shows a diagrammatic representation of the machine 1900 in the example form of a computer system and within which instructions 1924 (e.g., software) for causing the machine 1900 to perform any one or more of the methodologies discussed herein may be executed. In alternative examples, the machine 1900 operates as a standalone device or may be connected (e.g., networked) to other machines. In a networked deployment, the machine 1900 may operate in the capacity of a server machine or a client machine in a server-client network environment, or as a peer machine in a peer-to-peer (or distributed) network environment. The machine 1900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1924, sequentially or otherwise, that specify actions to be taken by that machine. Further, while only a single machine is illustrated, the term “machine” shall also be taken to include a collection of machines that individually or jointly execute the instructions 1924 to perform any one or more of the methodologies discussed herein.

The machine 1900 includes a processor 1902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1904, and a static memory 1906, which are configured to communicate with each other via a bus 1908. The machine 1900 may further include a graphics display 1910 (e.g., a plasma display panel (PDP), a light emitting diode (LED) display, a liquid crystal display (LCD), a projector, or a cathode ray tube (CRT)). The machine 1900 may also include an alphanumeric input device 1912 (e.g., a keyboard), a cursor control device 1914 (e.g., a mouse, a touchpad, a trackball, a joystick, a motion sensor, or other pointing instrument), a storage unit 1916, a signal generation device 1918 (e.g., a speaker), and a network interface device 1920.

The storage unit 1916 includes a machine-readable medium 1922 on which is stored the instructions 1924 (e.g., software) embodying any one or more of the methodologies or functions described herein. The instructions 1924 may also reside, completely or at least partially, within the main memory 1904, within the processor 1902 (e.g., within the processor's cache memory), or both, during execution thereof by the machine 1900. Accordingly, the main memory 1904 and the processor 1902 may be considered as machine-readable media. The instructions 1924 may be transmitted or received over a network 1926 via the network interface device 1920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1922 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1900), such that the instructions, when executed by one or more processors of the machine (e.g., processor 1902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A memory device, the memory device communicatively coupled to a processor and comprising instructions which, when performed on the processor, cause the processor to:
receive data relating to a job candidate for an employment position;
display the data on a computer display device having a touch sensitive screen;
receive an input from a user via the touch sensitive screen, the input relating to a decision on the job candidate for the employment position; and
store, discard, or forward the decision or the data relating to the job candidate to another memory device based on the input from the user.

2. The memory device of claim 1, wherein the data relates to a resume or a profile associated with an online social networking service.

3. The memory device of claim 1, wherein the memory device comprises a mobile communications device.

4. The memory device of claim 1, wherein the input indicates an acceptance of the job candidate, a rejection of the job candidate, a hold or deferral of the job candidate, or a referral of the job candidate.

5. The memory device of claim 4, wherein the input from the user comprises a sweeping motion in a first direction to indicate the acceptance, a sweeping motion in a second direction to indicate the rejection, a sweeping motion in a third direction to indicate the hold or deferral, and a sweeping direction in a fourth direction to indicate the referral.

6. The memory device of claim 1, comprising instructions to cause the computer processor to display an icon on the computer display device, and instructions to receive the input from the user via the icon.

7. The memory device of claim 1, comprising instructions to cause the computer processor to receive input from the job candidate; and to modify the data relating to the job candidate based on the input from the job candidate.

8. The memory device of claim 7, wherein the modification of the data relating to the job candidate relates to one or more of deleting data relating to the job candidate, adding data relating to the job candidate, and highlighting data relating to the job candidate.

9. The memory device of claim 1, comprising instructions to cause the computer processor to generate a ranking of the job candidate compared to other job candidates based on the input of the user.

10. The memory device of claim 1, wherein the computer display device comprises a plurality of sections or windows, the plurality of sections or windows comprising one or more of a name of the job candidate, a photograph of the job candidate, a highlighted attribute of the job candidate, a social connection of the job candidate, an education history of the job candidate, an employment history of the job candidate, and a skills summary of the job candidate.

11. A memory device, the memory device communicatively coupled to a processor and comprising instructions which, when performed on the processor, cause the processor to:
transmit to a user device data relating to a job candidate for an employment position;
display the data on the user device, the user device comprising a touch sensitive screen;
receive an input from a user via the touch sensitive screen, the input relating to a decision on the job candidate for the employment position; and
store the decision in the memory device, discard the decision, or forward the decision to another user device based on the input from the user.

15. A system comprising:
a computer processor operable for:
receiving data relating to a job candidate for an employment position;
displaying the data on a computer display device having a touch sensitive screen;
receiving an input from a user via the touch sensitive screen, the input relating to a decision on the job candidate for the employment position; and
storing, discarding, or forwarding the decision or the data relating to the job candidate to another memory device based on the input from the user.

16. The system of claim 15, wherein the input indicates an acceptance of the job candidate, a rejection of the job candidate, a hold or deferral of the job candidate, or a referral of the job candidate; and wherein the input from the user comprises a sweeping motion in a first direction to indicate the acceptance, a sweeping motion in a second direction to indicate the rejection, a sweeping motion in a third direction to indicate the hold or deferral, and a sweeping direction in a fourth direction to indicate the referral.

17. The system of claim 15, wherein the computer display device comprises a plurality of sections or windows, the plurality of sections or windows comprising one or more of a name of the job candidate, a photograph of the job candidate, a highlighted attribute of the job candidate, a social connection of the job candidate, an education history of the job candidate, an employment history of the job candidate, and a skills summary of the job candidate.

18. A process comprising:
receiving data relating to a job candidate for an employment position;
displaying the data on a computer display device having a touch sensitive screen;
receiving an input from a user via the touch sensitive screen, the input relating to a decision on the job candidate for the employment position; and
storing, discarding, or forwarding the decision or the data relating to the job candidate to another memory device based on the input from the user.

19. The process of claim 18, comprising generating a ranking of the job candidate compared to other job candidates based on the input of the user.

20. The process of claim 18, comprising:
receiving input from the job candidate; and
modifying the data relating to the job candidate based on the input from the job candidate;
wherein the modification of the data relating to the job candidate relates to one or more of deleting data relating to the job candidate, adding data relating to the job candidate, and highlighting data relating to the job candidate.
